(19) United States
(12) Patent Application Publication
(10) Pub. No.: US 2005/0153172 A1
(43) Pub. Date: Jul. 14, 2005

(54) Secondary battery

(76) Inventor: Kyu-Nam Han, Suwon-si (KR)

Correspondence Address: Robert E. Bushnell;Suite 300, 1522 K Street, N.W., Washington, DC, 20005-1202, US

(21) Appl. No.: 11/020,573

(22) Filed: Dec. 27, 2004

(30) Foreign Application Priority Data
Jan. 13, 2004 (KR) 2004-0002443

(51) Int. Cl. H01M 2/00

(52) U.S. Cl. 429/7; 429/175

(57) ABSTRACT

A secondary battery including: a bare cell including a container-type can, an electrode assembly arranged inside the can through an opening of the can and a cap assembly adapted to close the opening of the can; a protective circuit board coupled to at least one side of the bare cell so as to include a gap therebetween; and a plastic molding material formed in the gap and on a front surface of the protective circuit board; wherein at least one pathway to connect the plastic molding material that fills the gap with the plastic molding material disposed on the front surface of the protective circuit board is arranged in a portion of the protective circuit board.

### CLAIM OF PRIORITY

This application makes reference to, incorporates the same herein, and claims all benefits accruing under 35 U.S.C. § 19 from an application for Secondary Battery earlier filed in the Korean Intellectual Property Office on 13 Jan. 2003 and there duly assigned Ser. No. 2004-2443.

### BACKGROUND OF THE INVENTION

1. Field of the Invention

The present invention relates to a secondary battery, and more particularly to a secondary battery including a bare cell having an electrode assembly, a can and a cap assembly, and a protective circuit board electrically connected to the bare cell.

2. Description of the Related Art

As generally known in the art, secondary batteries are rechargeable and can be made in a compact form with a large capacity, and thus have been broadly researched and developed recently. Typical examples of such secondary batteries include nickel-metal hydride (Ni-MH) batteries, lithium (Li) batteries and lithium-ion (Li-ion) batteries.

However, a battery, as is, is an energy source, and can discharge a large amount of energy. In the case of a secondary battery, a high energy is stored in the secondary battery in a charged state thereof. Also, during the charging of the secondary battery, an external energy source is needed to supply the energy to be stored in the battery. When an internal short circuit or problem with the secondary battery occurs during the above described process or state, the energy stored in the battery can be discharged in a short period of time, thereby causing safety problems such as fire, explosion, or the like.

Accordingly, in general, a secondary battery is equipped with various kinds of safety devices for preventing fire or explosion caused by problems with the battery itself in a charged state or during the charging of the battery. These safety devices are generally connected to a positive terminal and a negative terminal of a bare cell through a conductive structure, a so-called lead plate. These safety devices can interrupt electric current, for example, when a battery is heated to a high temperature or a battery voltage rapidly increases due to overcharging or overdischarging, etc., thereby preventing explosion and fire of the battery. Typical examples of safety devices coupled to a bare cell include a protective circuit board that can detect abnormal electric current or voltage to interrupt electric current, a Positive Temperature Coefficient (PTC) device to detect the occurrence of overheating due to an abnormal electric current, a bimetal device, etc.

A secondary battery having a bare cell coupled to a safety device is initially contained in a separate casing to provide a secondary battery having a finished outer appearance. After this, a secondary battery is often provided as a plastic pack-type secondary battery, in which the terminals of a bare cell and those of a safety device such as a protective circuit board are coupled by welding, and then the bare cell coupled to the protective circuit board is arranged in a mold in order to fill the space between the bare cell and the protective circuit board or to completely cover the circumference of the safety device with a resin molding, thereby physically coupling the bare cell to the protective circuit board.

In the case of a plastic-pack type secondary battery, there is an advantage compared to a secondary battery in which a core pack composed of a bare cell coupled to a protective circuit board is contained in a casing, the advantage being that the outer appearance of the battery becomes neat by virtue of a molding, the thickness of the battery can be reduced by eliminating the thickness of a casing, and the inconvenience occurring when the battery is inserted in a casing is avoided.

In a pack-type battery, a protective circuit board is disposed parallel to the surface of a bare cell, on which electrode terminals are formed. The bare cell includes a positive terminal and a negative terminal on the surface facing the protective circuit board. The positive terminal can be a cap plate itself, formed of aluminum or aluminum alloys, or a nickel-containing metal plate coupled to a cap plate. The negative terminal protrudes from a cap plate, and is electrically isolated from the cap plate by a peripheral insulator gasket.

The protective circuit board includes a panel formed of a resin, on which a circuit is disposed, and external terminals, etc., formed on the outer surface thereof. The protective circuit board has a dimension and a shape, which are substantially the same as those of the surface (cap plate surface) of the bare cell facing thereto.

The back surface of the protective circuit board opposite to the surface having external terminals, i.e., the internal surface of the protective circuit board, is equipped with a circuit section and connection terminals The circuit section includes, for example, a protective circuit to protect a battery from overcharging or overdischarging during the charging/discharging of the battery. The circuit section and each external terminal are electrically connected to each other by a conductive structure passing through the protective circuit board.

Connection leads and an insulating plate, etc., are disposed between the bare cell and the protective circuit board. The connection leads, generally formed of nickel, are used to make an electrical connection between the cap plate and each connection terminal of the protective circuit board. They can have an “L”-shaped form or a planar structure. In order to make an electrical connection between each connection lead and each terminal, a resistance spot welding method can be used.

A separate breaker is arranged in a connection lead disposed between the protective circuit board and the negative terminal. In this case, the circuit section of the protective circuit board has no breaker. The insulating plate serves as electrical insulation between the connection lead connected to the negative terminal and the cap plate as a positive terminal.

When the assembly composed of a bare cell coupled to a protective circuit board is arranged on a mold and a resin is poured to form a molded plastic so that a plastic pack-type secondary battery can be obtained, a first space and a second space can be filled with the resin. It is not problematic that the first space directly connected to an inlet is filled with the resin. However, it is quite problematic that the space is filled with the resin. In other words, because the second space is supplied with the resin through the first space, the protective circuit board can prevent the resin from flowing between both spaces in the absence of a separate connection pathway for both spaces. This results from the fact that the inner space of a mold for plastic molding has a substantially uniform shape both in the side of a protective circuit board and the side of a bare cell, and that the protective circuit board has substantially the same size as the cap plate of the bare cell.

When the resin flow is disturbed, gaps or pinholes can be generated in the mold, and thus the mechanical strength of the plastic molding is reduced, the outer appearance is deteriorated and the resin-filling rate is decreased, thereby reducing the processing efficiency. In order to increase the resin-filling rate, the temperature of the resin has to be increased, or the pouring pressure of the resin has to be increased. In this case, a PTC device, etc., disposed in contact with the mold can be functionally destroyed, or the protective circuit board can be dislocated, and thus an external terminal surface is stained and covered with the resin. Providing a separate pathway for the mold for plastic molding has a problem in that it complicates the manufacturing process of the mold and frequently needs post-molding treatments, thereby increasing the manufacturing cost of the battery.

To solve the problem, the protective circuit board can be formed to have a size smaller than that of the cap plate of the bare cell. However, such a small protective circuit board has a problem in that it can complicate the formation of elements needed for the protective circuit board, thereby increasing the cost. Additionally, it becomes difficult to mount the protective circuit board on the mold for plastic molding, so that the protective circuit board can dislocate. In this case, even if the plastic molding is completed, external terminals can be moved away from their correct positions so that they are not exposed to the exterior.

### SUMMARY OF THE INVENTION

Accordingly, it is an object of the present invention to provide a secondary battery formed in such a manner that a protective circuit board does not disturb the flow of a resin during the formation of a plastic molding with no need of reducing the overall size of the protective circuit board.

It is another object of the present invention to provide a secondary battery formed in such a manner that the generation of gaps or pinholes can be prevented in all spaces wherein a plastic molding is to be formed, with no need of increasing the temperature or pressure of a resin to be introduced.

In order to accomplish these objects, a secondary battery is provided including: a bare cell including a container-type can, an electrode assembly arranged inside the can through an opening of the can and a cap assembly adapted to close the opening of the can; a protective circuit board coupled to at least one side of the bare cell so as to include a gap therebetween; and a plastic molding material formed in the gap and on a front surface of the protective circuit board; wherein at least one pathway to connect the plastic molding material that fills the gap with the plastic molding material disposed on the front surface of the protective circuit board is arranged in a portion of the protective circuit board.

The at least one pathway preferably comprises at least one opening arranged in a portion of the protective circuit board having no circuit therein.

The at least one pathway preferably comprises indentations on a circumferential edge of the protective circuit board, the indentations forming a pathway together with an inner surface of a mold to effect plastic molding, upon the protective circuit board coupled to the bare cell being arranged on the mold.

The at least one pathway preferably comprises at least one groove on a circumferential edge of the protective circuit board.

The at least one pathway preferably comprises at least one chamfer arranged at a corner of the protective circuit board.

The at least one pathway preferably has a diameter or minimum width of at least 1 mm.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic exploded perspective view of a pack-type lithium-ion battery, before coupling to a plastic molding;

FIG. 2 is a sectional view of a plastic pack-type secondary battery, in which an assembly composed of a bare cell and a protective circuit board are mounted on a mold prior to plastic molding;

FIG. 3 is an exploded perspective view of a lithium pack-type battery including an assembly composed of a bare cell part coupled to a protective circuit board, according to an embodiment of the present invention;

FIG. 4 is a lateral sectional view of a secondary battery, including an assembly composed of a bare cell coupled to a protective circuit board, the secondary battery being mounted on a mold prior to plastic molding, according to an embodiment of the present invention, as taken from a section passing through one of the openings of the protective circuit board;

FIG. 5 is a schematic plan view of the outlines of the surface of a protective circuit board, on which grooves are formed along the circumferential edges, according to another embodiment of the present invention;

FIG. 6 is a lateral sectional view of a secondary battery assembly using the protective circuit board of FIG. 5 and mounted on a mold prior to plastic molding, as taken from a section passing through the grooves; and

FIG. 7 is a schematic view of a protective circuit board according to still another embodiment of the present invention, in which chamfers are formed at the corners of the protective circuit board.

### DETAILED DESCRIPTION OF THE PRESENT INVENTION

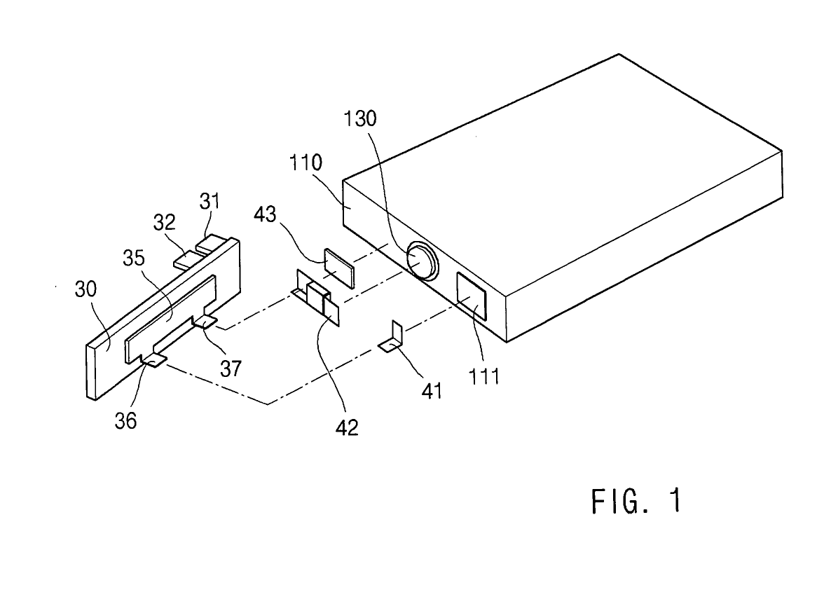

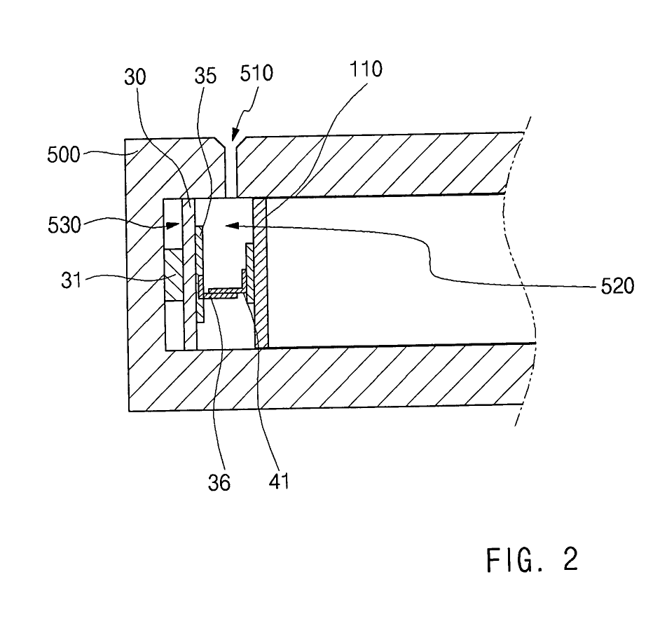

FIG. 1 is a schematic exploded perspective view of a pack-type lithium-ion battery, before coupling to a plastic molding. FIG. 2 is a sectional view of a plastic pack-type secondary battery, in which an assembly composed of a bare cell and a protective circuit board is mounted on a mold prior to plastic molding.

For the convenience of illustration, the central line is shown in a folded shape in FIG. 1. However, in a pack-type battery, a protective circuit board 30 is disposed parallel to the surface of a bare cell, on which electrode terminals 130 and 111 are formed. The bare cell includes a positive terminal 111 and a negative terminal 130 on the surface facing the protective circuit board 30. The positive terminal 111 can be a cap plate itself, formed of aluminum or aluminum alloys, or a nickel-containing metal plate coupled to a cap plate. The negative terminal 130 protrudes from a cap plate 110, and is electrically isolated from the cap plate 110 by a peripheral insulator gasket.

The protective circuit board 30 includes a panel formed of a resin, on which a circuit is disposed, and external terminals 31, 32, etc., formed on the outer surface thereof. The protective circuit board 30 has a dimension and a shape, which are substantially the same as those of the surface (cap plate surface) of the bare cell facing thereto.

The back surface of the protective circuit board 30 opposite to the surface having external terminals 31, 32, i.e., the internal surface of the protective circuit board, is equipped with a circuit section 35 and connection terminals 36 and 37. The circuit section 35 includes, for example, a protective circuit to protect a battery from overcharge/overdischarge during charging/discharging of the battery. The circuit section 35 and each external terminal 31 and 32 are electrically connected to each other by a conductive structure passing through the protective circuit board 30.

Connection leads 41 and 42 and an insulating plate 43, etc., are disposed between the bare cell and the protective circuit board 30. The connection leads 41 and 42, generally formed of nickel, are used to make an electrical connection between the cap plate 110 and each connection terminal 36 and 37 of the protective circuit board 30. They can have an “L”-shaped form or a planar structure. In order to make an electrical connection between each connection lead 41 and 42 and each terminal 36 and 37, a resistance spot welding method can be used.

In the embodiment as shown in FIG. 1, a separate breaker is arranged in a connection lead 42 disposed between the protective circuit board and the negative terminal. In this case, the circuit section 35 of the protective circuit board has no breaker. The insulating plate 43 serves as electrical insulation between the connection lead 42 connected to the negative terminal 130 and the cap plate as a positive terminal.

As shown in FIG. 2, when the assembly composed of a bare cell coupled to a protective circuit board 30 is arranged on a mold and a resin is poured to form a molded plastic so that a plastic pack-type secondary battery can be obtained, a first space 520 and a second space 530 can be filled with the resin. It is not problematic that the first space 520 directly connected to an inlet 510 is filled with the resin. However, it is quite problematic that the space 530 is filled with the resin. In other words, because the second space 530 is supplied with the resin through the first space 520, the protective circuit board 30 can prevent the resin from flowing between both spaces in the absence of a separate connection pathway for both spaces. This results from the fact that the inner space of a mold 500 for plastic molding has a substantially uniform shape both in the side of a protective circuit board 30 and the side of a bare cell, and that the protective circuit board has substantially the same size as the cap plate 110 of the bare cell.

Hereinafter, embodiments of the present invention will be described with reference to the accompanying drawings. In the following description and drawings, the same reference numerals are used to designate the same or similar components, and so repetition of the description on the same or similar components has been omitted.

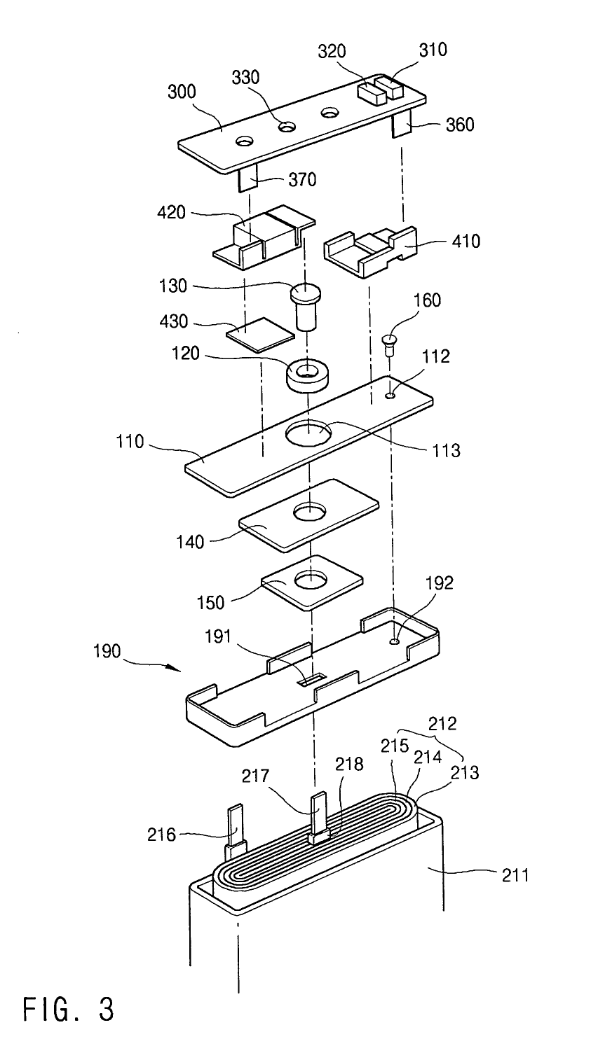

FIG. 3 is an exploded perspective view of a lithium pack-type battery including an assembly composed of a bare cell part coupled to a protective circuit board, according to an embodiment of the present invention.

Referring to FIG. 3, a lithium pack-type battery has a bare cell including a can 211, an electrode assembly 212 contained inside of the can 211 and a cap assembly attached to and sealing the open top of the can 211.

The electrode assembly 212 is formed by winding a layered body of a positive electrode 213, a separator 214 and a negative electrode 215, which takes the form of a thin film or plate, in a spiral shape.

The positive electrode 213 includes a positive electrode collector formed of a highly conductive metal thin plate such as aluminum foil, and a positive electrode active material layer coated on both surfaces of the positive electrode collector, the positive electrode active material being based on a lithium-containing oxide. A positive electrode lead 216 is electrically connected to a section having no positive electrode material layer in the positive electrode collector.

The negative electrode 215 includes a negative electrode collector formed of a conductive metal thin plate such as copper foil, and a negative electrode active material layer coated on both surfaces of the negative electrode collector, the negative electrode active material being based on a carbonaceous material. Also, a negative electrode lead 217 is electrically connected to a section having no negative electrode material layer in the negative electrode collector.

The positive electrode 213 and the negative electrode 215 as well as the positive electrode lead 216 and the negative electrode lead 217 can be disposed by changing their polarities. Additionally, a border part at which the positive and negative leads 216 and 217 are drawn from the electrode assembly 212 is covered with an insulating tape 218 to prevent an electrical short between the electrodes 213 and 215.

The separator 214 can be formed of polyethylene, polypropylene or copolymers of polyethylene with polypropylene. It is preferable that the separator 214 is formed to have a width greater than the widths of the positive and negative electrodes 213 and 215 so as to prevent an electrical short between the electrode plates.

The square type can 211 as shown in FIG. 3 is made of aluminum or aluminum alloys 18 having an approximately hexahedral shape. The electrode assembly 212 is inserted into the can 211 through the open top of the can 211, and then the can 211 functions as a container for the electrode assembly 212 and an electrolyte. The can 211, as is, can function as a terminal. However, a cap plate 110 of a cap assembly functions as a positive terminal in the embodiment of FIG. 3.

The cap assembly is equipped with a planar cap plate 110 having a size and shape corresponding to that of the open top of the can 211. The central part of the cap plate 110 has a aperture 113 through which the electrode terminals can pass. A tubular gasket 120 is disposed on the exterior of the negative terminal 130 passing through the central part of the cap plate 110 to electrically insulate the negative terminal 130 from the cap plate 110. An insulating plate 140 is disposed on the bottom surface of the cap plate 110 in the vicinity of the central part of the cap plate 110 and the aperture 113. A terminal plate 150 is disposed on the bottom surface of the insulating plate 140.

The negative terminal 130 is inserted through the aperture 113, wherein the outer circumference of the aperture 113 is surrounded by the gasket 120. The bottom of the negative terminal 130 is electrically connected from the terminal plate 150, wherein the insulating plate 140 is inserted between them.

The positive electrode lead 216 drawn from the positive electrode 213 is welded at the bottom of the cap plate 110, and the negative electrode lead 217 drawn from the negative electrode 215 is welded at the bottom of the negative terminal 130 in a folded state.

On the top surface of the electrode assembly 212, an insulating casing 190 is disposed to electrically insulate the electrode assembly 212 from the cap assembly and to cover the top of the electrode assembly 212. A aperture 191, through which the central part of the electrode assembly 212 and the negative electrode lead 217 can pass, is formed in the insulating casing 190. Additionally, an electrolyte passage hole 192 is formed at one side of the insulating case 190.

An electrolyte injection hole 112 is formed at one side of the cap plate 110. The electrolyte injection hole 112 is equipped with a stopper 160 in order to seal the electrolyte injection hole after the injection of electrolyte. In order to couple the cap assembly to the can 211, the circumference of the cap plate 110 are welded to the sidewalls of the can 211.

A lead plate 410 is welded to the circumference of the stopper 160 on the cap plate 110, wherein the lead plate 410 has parallel sidewalls connected to each other by a bridge portion at their bottoms and a aperture corresponding to the stopper 160. Although the lead plate is provided for electrical connection, it can affix the plastic molding to the bare cell by being embedded into the plastic molding when the sidewalls protrude toward the plastic molding at the interface between the sidewalls and the plastic molding.

The lead plate 410 is preferably made of nickel, nickel alloys or nickel-plated stainless steel materials. The thickness of the lead plate 410 is related to the thickness of the can and welding options. If the lead plate 410 has a large thickness, there is an advantage in that a pack-type battery obtained by filling a resin into a space between the can 211 sealed by the cap assembly and the protective circuit board 300 can have increased resistance against any applied external forces when the battery is twisted or bent.

The protective circuit board 300 has a circuit including circuit chips on a synthetic resin panel. A part of the protective circuit board 300, in which no circuit is formed, has at least one circular or rectangular opening 330.

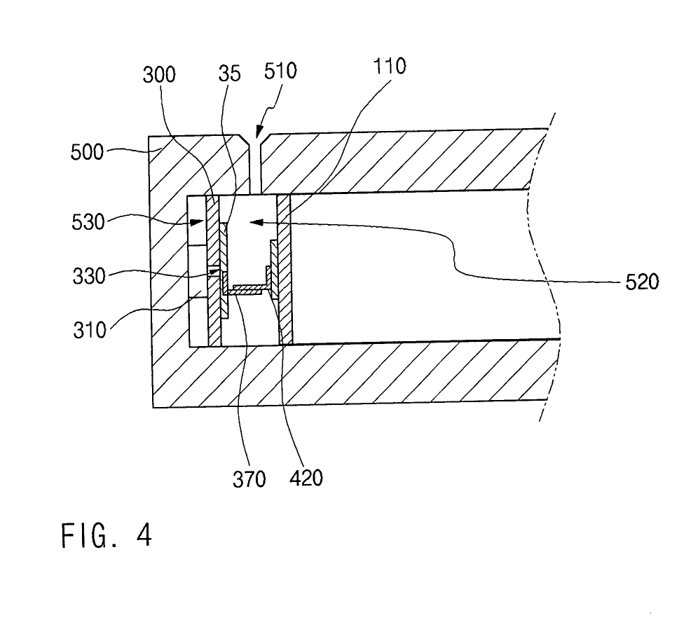

FIG. 4 is a lateral sectional view of a secondary battery, including an assembly composed of a bare cell coupled to a protective circuit board, the secondary battery being arranged on a mold prior to plastic molding, according to an embodiment of the present invention, as taken from a section passing through one of the openings of the protective circuit board.

As shown in FIG. 4, when a liquid resin is introduced through an injection hole 510, the resin begin to fill a first space 520 and then the level of the liquid resin is gradually increased. Of course, a part of the resin can gradually fill a second space 530 through a minute gap between the mold 500 and the protective circuit board 300. When the level of the liquid resin reaches the opening 330, the liquid resin can move quickly to the second space 530 through the opening 330 and fill the second space 530 at a level-increasing rate higher than that of the first space 520. While the size of the opening is determined by considering the resin viscosity, filling rate demanded in the manufacturing process, etc., it is preferable that the opening has a diameter or minimum width of at least 1 mm.

Accordingly, the liquid levels in the first space and the second space are equalized, and thus all of the spaces are filled with the resin. Air that originally occupied the spaces is evacuated through a minute gap between the top of the inner space of the mold 500 and the protective circuit board 300, and thus can be discharged through an air discharging port (not shown) formed in parallel with the injection hole 510, or a crack present in the mold.

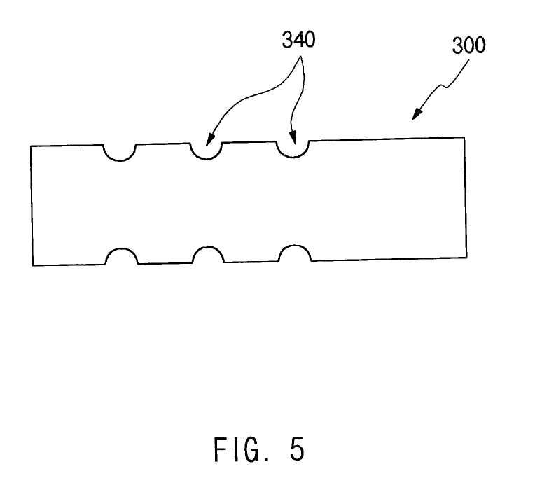

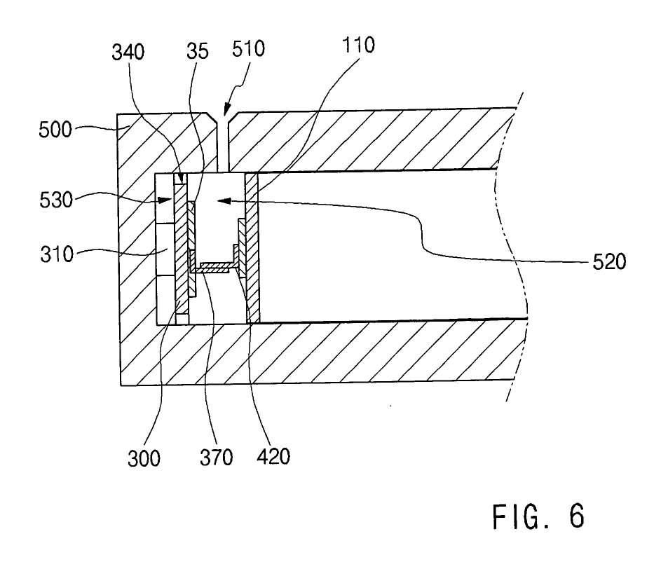

FIG. 5 is a schematic plan view of the outlines of the surface of a protective circuit board according to another embodiment of the present invention; and FIG. 6 is a lateral sectional view of a secondary battery assembly using the protective circuit board of FIG. 5, the secondary battery assembly being arranged on a mold prior to plastic molding, with the proviso that the lateral section in FIG. 6 passes through the grooves formed along the circumferential edge of the protective circuit board of FIG. 5.

In another embodiment of the present invention, as shown in FIG. 5, grooves 340 are formed along the circumferential edge of the protective circuit board 300, instead of the apertures formed in the protective circuit board. Similarly, the grooves 340 can be made as large as possible on a non-circuit portion of the protective circuit board 300.

Referring to FIG. 6, when a liquid resin is introduced through the injection hole 510, the resin fills the first space 520. As the level of the liquid resin increases in the first space 520, the resin gradually flows into the second space 530 through the grooves 340 formed on the bottom of the protective circuit board by virtue of the pressure caused by the difference between the liquid levels of the first space and the second space. In this manner, the liquid resin introduced into the first space also fills the second space. If the grooves formed on the lower part have a sufficiently large size, the liquid levels of the first space 520 and the second space 530 can increase at approximately the same rate, and thus both spaces are filled with the resin together. Air that has originally occupied the spaces is evacuated through a minute gap between the top of the inner space of the mold for plastic molding and the protective circuit board, as in the embodiment of FIG. 5. Moreover, air can be discharged sufficiently through the grooves formed on the upper part.

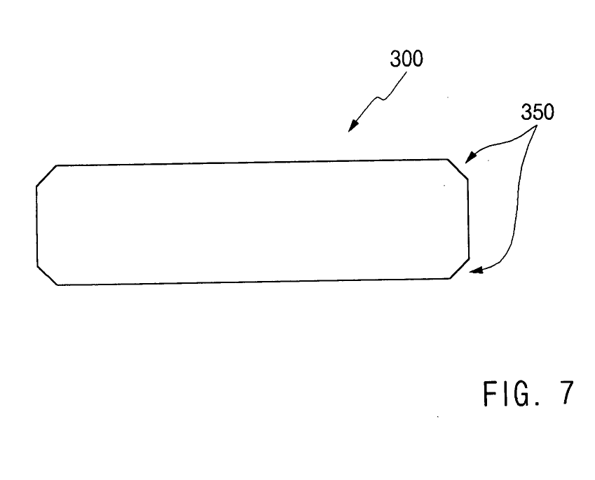

FIG. 7 is a schematic view of a protective circuit board according to still another embodiment of the present invention, in which chamfers 350 are formed at the corners of the protective circuit board 300, instead of the apertures in the protective circuit board. Similarly, the chamfers 350, together with the inner walls of the angular corner parts of the mold 500, can provide a pathway for connecting the plastic resin that fills the gap between the protective circuit board and the bare cell with the plastic molding being disposed on the front surface of the protective circuit board.

As can be seen from the foregoing, according to the present invention, a resin for plastic molding can flow through the openings or grooves formed on a protective circuit board during the formation of plastic molding with no need of reducing the overall size of the protective circuit board. Therefore, the resin can flow between two spaces divided by the protective circuit board, and thus it is possible to form a plastic molding uniformly at all spaces.

Accordingly, It is possible to prevent the generation of gaps or pinholes in all spaces wherein plastic molding is to be formed with no need of increasing the temperature or pressure of a resin to be introduced.

Although embodiments of the present invention have been described for illustrative purposes, those skilled in the art will appreciate that various modifications, additions and substitutions are possible, without departing from the scope and spirit of the invention as defined by the accompanying claims.

1. A secondary battery comprising:
a bare cell including a container-type can, an electrode assembly arranged inside the can through an opening of the can and a cap assembly adapted to close the opening of the can;
a protective circuit board coupled to at least one side of the bare cell so as to include a gap therebetween; and
a plastic molding material formed in the gap and on a front surface of the protective circuit board;
wherein at least one pathway to connect the plastic molding material that fills the gap with the plastic molding material disposed on the front surface of the protective circuit board is arranged in a portion of the protective circuit board.

2. A secondary battery as claimed in claim 1, wherein the at least one pathway comprises at least one opening arranged in a portion of the protective circuit board having no circuit therein.

3. A secondary battery as claimed in claim 1, wherein the at least one pathway comprises indentations on a circumferential edge of the protective circuit board, the indentations forming a pathway together with an inner surface of a mold to effect plastic molding, upon the protective circuit board coupled to the bare cell being arranged on the mold.

4. A secondary battery as claimed in claim 1, wherein the at least one pathway comprises at least one groove on a circumferential edge of the protective circuit board.

5. A secondary battery as claimed in claim 1, wherein the at least one pathway comprises at least one chamfer arranged at a corner of the protective circuit board.

6. A secondary battery as claimed in claim 1, wherein the at least one pathway has a diameter or minimum width of at least 1 mm.

7. A secondary battery as claimed in claim 2, wherein the at least one pathway has a diameter or minimum width of at least 1 mm.

8. A secondary battery as claimed in claim 3, wherein the at least one pathway has a diameter or minimum width of at least 1 mm.

9. A secondary battery as claimed in claim 4, wherein the at least one pathway has a diameter or minimum width of at least 1 mm.

10. A secondary battery as claimed in claim 5, wherein the at least one pathway has a diameter or minimum width of at least 1 mm.
